(19) United States
(12) Patent Application Publication
(10) Pub. No.: US 2007/0014462 A1
(43) Pub. Date: Jan. 18, 2007

(54) Constrained surface evolutions for prostate and bladder segmentation in CT images

(76) Inventors: Mikael Rousson, Trenton, NJ (US); Ali Khamene, Princeton, NJ (US); Mamadou Diallo, Montreal (CA)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/452,169

(22) Filed: Jun. 13, 2006

Related U.S. Application Data
(60) Provisional application No. 60/698,763, filed on Jul. 13, 2005.

(51) Int. Cl. G06K 9/00; G06K 9/34

(52) U.S. Cl. 382/128; 382/173

(57) ABSTRACT

A Bayesian formulation for coupled surface evolutions in level set methods and application to the segmentation of the prostate and the bladder in CT images are disclosed. A Bayesian framework imposing a shape constraint on the prostate is also disclosed, while coupling its shape extraction with that of the bladder. Constraining the segmentation process improves the extraction of both organs' shapes.

### CROSS-REFERENCE TO RELATED APPLICATIONS

This application claims the benefit of U.S. Provisional Application No. 60/698,763, filed Jul. 13, 2005, which is incorporated herein by reference.

### BACKGROUND OF THE INVENTION

The present invention relates to segmentation of objects in medical images. More specifically it relates to the segmentation of bladder and prostate in an image and detection of the bladder-prostate interface.

Accurate contouring of the gross target volume (GTV) and critical organs is a fundamental prerequisite for successful treatment of cancer by radiotherapy. In adaptive radiotherapy, the treatment plan is further optimized according to the location and the shape of anatomical structure during the treatment sessions. Successful implementation of adaptive radiotherapy calls for development of a fast, accurate and robust method for automatic contouring of GTV and critical organs. This task is specifically more challenging in the case of the prostate cancer. The main reason is first, there is almost no intensity gradient at the bladder-prostate interface. Second, the bladder and rectum fillings change from one treatment session to another and that causes variation in both shape and appearance. Third, the shape of the prostate changes mainly due to boundary conditions, which are set (due to pressure) from bladder and rectum fillings.

Accordingly novel and improved methods for bladder-prostate segmentation are required.

### SUMMARY OF THE INVENTION

One aspect of the present invention presents a novel method and system that provides an accurate and stable segmentation of two organs from image data comprising two organs which have a closely coupled interface.

In accordance with one aspect of the present invention, a method for segmenting a first structure and a second structure from image data involves forming an energy function E=f(E_{data}, E_{coupling}), wherein E_{data} represents a possible segmentation based on the first structure and the second structure and E_{coupling} represents a measure of overlap between the first structure and the second structure. Then the energy function is minimized.

E can be represented as E_{data}+E_{coupling}. E_{data} and E_{coupling} can be logarithmic expressions. Further, the terms E_{data} and E_{coupling} can depend on the probability of a level set function of the first structure and of the second structure. It is preferred that E_{coupling} depends on a penalty α. The penalty α can be user defined and/or provided by a user as part of application software.

In accordance with one aspect of the invention, the term E_{data} can be expressed as:

$$\begin{matrix}{E}_{data} ( {ϕ}_{1} , {ϕ}_{2} ) = - {\int }_{Ω}^{} {H}_{ɛ} ( {ϕ}_{1 , x} ) ( 1 - {H}_{ɛ} ( {ϕ}_{2 , x} ) ) log {p}_{1} ( I ( x ) ) ⅆ x \\ - {\int }_{Ω}^{} {H}_{ɛ} ( {ϕ}_{2 , x} ) ( 1 - {H}_{ɛ} ( {ϕ}_{1 , x} ) ) log {p}_{2} ( I ( x ) ) ⅆ x \\ - {\int }_{Ω}^{} ( 1 - {H}_{ɛ} ( {ϕ}_{2 , x} ) ( 1 - {H}_{ɛ} ( {ϕ}_{1 , x} ) ) log {p}_{b} ( I ( x ) ) ⅆ x\end{matrix}$$

and the term E_{coupling} can be expressed as:
E_{coupling}(φ₁,φ₂)=α∫_{Ω}H_{ε}(φ_{1,x})H_{ε}(φ_{2,x})dx.

In accordance with a further aspect of the present invention, a third term Eₛₕₐₚₑ is added which expresses a constraint of learned prior shapes. The term Eₛₕₐₚₑ can be expressed as
Eₛₕₐₚₑ=−log p(φ|{φ¹, . . . , φ^{N}}.

In accordance with a further aspect of the present invention, the first structure is a prostate and the second structure is a bladder. Other organs in a human body that are next to each other can also be segmented in accordance with the methods and systems of the present invention. Additionally, any neighboring objects can also be segmented in accordance with the methods and systems of the present invention.

A system that can segment a first structure and a second structure from image data that includes a processor and application software operable on the processor is also provided in accordance with one aspect of the present invention. The application software can perform all of the methods described herein.

### DESCRIPTION OF THE DRAWINGS

FIG. 1 illustrates the segmentation of two neighboring structures.

FIG. 2 provides a prostate shape model.

FIG. 3 illustrates segmentation with and without coupling.

FIG. 4 illustrates segmentation achieved in accordance with an aspect of the present invention.

FIG. 5 illustrates a series of steps performed in accordance with one aspect of the present invention.

FIG. 6 illustrates a computer system that is used to perform the steps described herein in accordance with another aspect of the present invention.

### DESCRIPTION OF A PREFERRED EMBODIMENT

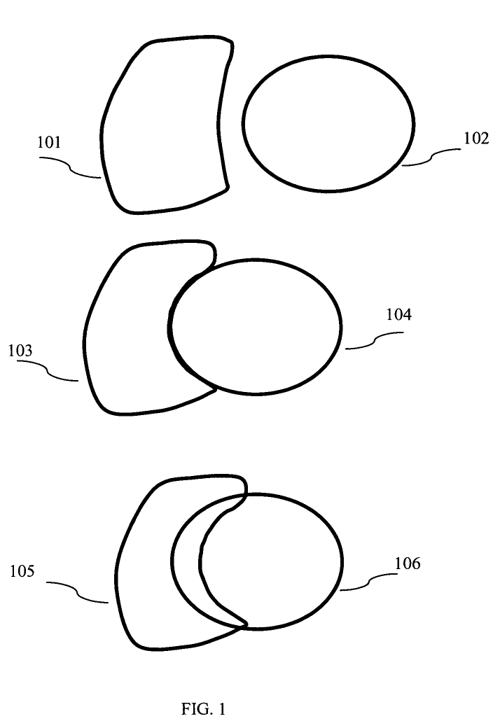

When imaging medical structures, it is sometimes necessary to segment two neighboring structures. In these cases, it is often desirable to separately segment each structure. It is common that two neighboring structures actually touch each other. Less than optimal gradients in image properties of the touching regions of the structures may create problems in the segmentation process. For instance overlapping of the two structures is a problem in the segmentation process. This is illustrated in the three scenarios in FIG. 1. In the first scenario, objects 101 and 102 are to be segmented. The objects 101 and 102 are slightly separated and there is no problem in the segmentation process. In the second scenario, objects 103 and 104 are to be separated. The objects 103 and 104 are touching and the object 104 actually may have influenced the shape of object 103. In this case, the segmentation of the objects 103 and 104 results in a non-overlapping boundary between the objects 103 and 104 and is acceptable. The third scenario involves objects 105 and 106 and the segmentation of these objects results in an overlap of the objects. Also in this case object 106 may have influenced the shape of object 105. Actual overlap of objects is physically impossible. The overlap as shown in the diagram is therefore not acceptable. The creation of correct non-overlapping segmentation of two touching or closely positioned structures is one aspect of the present invention.

The introduction of prior shape knowledge is often vital in medical image segmentation due to the problems outlined above and in the following references: [2] T. Cootes, C. Taylor, D. Cooper, and J. Graham. Active shape models-their training and application. Computer Vision and Image Understanding, 61(1):38-59, 1995; [3] D. Cremers, S. J. Osher, and S. Soatto. Kernel density estimation and intrinsic alignment for knowledge-driven segmentation: Teaching level sets to walk. Pattern Recognition, 3175:36-44, 2004; [5] E. B. Dam, P. T. Fletcher, S. Pizer, G. Tracton, and J. Rosenman. Prostate shape modeling based on principal geodesic analysis bootstrapping. In MICCAI, volume 2217 of LNCS, pages 1008-1016, September 2004; [6] D. Freedman, R. J. Radke, T. Zhang, Y. Jeong, D. M. Lovelock, and G. T. Chen. Model-based segmentation of medical imagery by matching distributions, IEEE Trans Med Imaging, 24(3):281-292, March 2005; [7] M. Leventon, E. Grimson, and O. Faugeras. Statistical Shape Influence in Geodesic Active Contours. In Proceedings of the International Conference on Computer Vision and Pattern Recognition, pages 316-323, Hilton Head Island, S.C., June 2000; [10] M. Rousson, N. Paragios, and R. Deriche. Implicit active shape models for 3d segmentation in mr imaging. In MICCAI. Springer-Verlag, September 2004; and [11] A. Tsai, W. Wells, C. Tempany, E. Grimson, and A. Willsky. Mutual information in coupled multi-shape model for medical image segmentation. Medical Image Analysis, 8(4):429-445, December 2004. In the reference D. Freedman, R. J. Radke, T. Zhang, Y. Jeong, D. M. Lovelock, and G. T. Chen. Model-based segmentation of medical imagery by matching distributions, IEEE Trans Med Imaging, 24(3):281-292, March 2005, the authors use both shape and appearance models for the prostate, bladder, and rectum. In the reference E. B. Dam, P. T. Fletcher, S. Pizer, G. Tracton, and J. Rosenman. Prostate shape modeling based on principal geodesic analysis bootstrapping. In MICCAI, volume 2217 of LNCS, pages 1008-1016, September 2004, the authors propose a shape representation and modeling scheme that is used during both the learning and the segmentation stage.

The approach which is an aspect of the present invention is focused on segmenting the bladder and prostate only. A significant differentiator of this approach from the other ones in the cited references is the fact that there is no effort to enforce the shape constraints on the bladder. The main reason is to increase the versatility and applicability of the present method on larger number of datasets. One argument for this is that the bladder filling dictates the shape of the bladder; therefore the shape is not statistically coherent to be used for building shape models and the consequent model based segmentation. However, the shape of the prostates across large patient population show statistical coherency. Therefore, a coupled segmentation framework is presented with no overlap constraints, where the shape prior, depending on the availability, can be applied on any of the shapes. Related works propose to couple two level set propagations such as described in the reference N. Paragios and R. Deriche, Geodesic active regions: a new paradigm to deal with frame partition problems in computer vision. Journal of Visual Communication and Image Representation, Special Issue on Partial Differential Equations in Image Processing, Computer Vision and Computer Graphics, 13(1/2):249-268, March/June 2002; and the earlier reference A. Tsai, W. Wells, C. Tempany, E. Grimson, and A. Willsky, Mutual information in coupled multi-shape model for medical image segmentation. Medical Image Analysis, 8(4):429-445, December 2004.

In the approach according to an aspect of the present invention, the coupling is formulated in a Bayesian inference framework. This drives to the coupled surface evolutions, where overlap is reduced or minimized. Overlap is not completely forbidden as a possible outcome, but it is preferred to give a very low probability to overlapping contours. Increasing the weight of the coupling term will make overlaps almost impossible.

The level set representation as described for instance in earlier cited reference [8] permits to describe and deform a surface without introducing any specific parameterization and/or a topological prior. Let Ω∈R³ be the image domain, it represents a surface S∈Ω by zero crossing of an higher dimensional function φ, usually defined as a signed distance function:

$$ϕ ( x ) = \{ \begin{matrix}0 , & if x ∈ S , \\ + D ( x . S ) , & if x is inside S , \\ - D ( x , S ) , & if x is outside S .\end{matrix} \qquad ( 1 )$$

where D(x, S) is minimum Euclidean distance between the location x and the surface. This representation permits to express geometric properties of the surface like its curvature and normal vector at given location, area, volume, etc . . . It is then possible to formulate segmentation criteria and advance the evolutions in the level set framework.

In the particular problem of bladder-prostate segmentation, several structures need to be extracted from a single image. Rather than segmenting each one separately, a Bayesian framework will be provided where the most probable segmentation of all the objects is jointly estimated. The extraction of two structures represented by two level set functions φ₁ and φ₂ will be presented here. The optimal segmentations of a given image I is obtained by maximizing the joint posterior distribution p(φ₁,φ₂|I). Using the Bayesian theorem will provide:
p(φ₁,φ₂|I)∝p(I|φ₁,φ₂)p(φ₁,φ₂) (2)
The first term is the conditional probability of an image I and will be defined later using intensity properties of each structure. Other properties of the structure that could be used include density, appearance or any other property. The second term is the joint probability of the two surfaces. The latter term will be used to impose a non-overlapping constraint between the surfaces. Posteriori probability is often optimized by minimizing its negative logarithm. This gives the following energy functional for minimization process:

$$E ( {ϕ}_{1} , {ϕ}_{2} ) = \underbrace{- log p ( I \vert {ϕ}_{1} , {ϕ}_{2} )}_{{E}_{data}} \underbrace{- log p ( {ϕ}_{1} , {ϕ}_{2} )}_{{E}_{coupling}} \qquad ( 3 )$$

A gradient descent approach with respect to each level set is employed for the minimization. The gradients of each level sets can be computed, as follows:

$$\{ \begin{matrix}\frac{\partial {ϕ}_{1}}{\partial t} = - \frac{\partial {E}_{data}}{\partial {ϕ}_{1}} - \frac{\partial {E}_{coupling}}{\partial {ϕ}_{1}} \\ \frac{\partial {ϕ}_{2}}{\partial t} = - \frac{\partial {E}_{data}}{\partial {ϕ}_{2}} - \frac{\partial {E}_{coupling}}{\partial {ϕ}_{2}}\end{matrix} \qquad ( 4 )$$

Next the joint probability p(φ₁,φ₂) will be defined which serves as the coupling constraint between the surfaces. For this purpose, the assumptions are made that the level set values are spatially independent and that φ_{1,x} (the value of φ₁ at the position x) and φ_{2,x}, are independent for x≠y. The first assumption gives:

$$p ( {ϕ}_{1} , {ϕ}_{2} ) = {\prod }_{x ∈ Ω}^{} {\prod }_{y ∈ Ω}^{} p ( {ϕ}_{1 , x} , {ϕ}_{2 , y} ) \qquad ( 5 )$$

Using the second assumption and observing that the marginal probability of a level set value is uniform, this expression simplifies to:

$$p ( {ϕ}_{1} , {ϕ}_{2} ) ∝ {\prod }_{x ∈ Ω}^{} p ( {ϕ}_{1 , x} , {ϕ}_{2 , x} ) \qquad ( 6 )$$

In a first embodiment H is the Heaviside function. The non-overlapping constraint can then be introduced by adding a penalty, when the voxels are inside both structures, i.e. when H(φ₁) and H(φ₂) are equal to one:
p(φ_{1,x},φ_{2,x})∝exp(−αH(φ_{1,x})H(φ_{2,x})) (7)
where α is a weight controlling the importance of this term. It will be shown in a next section, that α can be set once for all. The corresponding term in the energy is:
E_{coupling}(φ₁,φ₂)=α∫_{Ω}H(φ_{1,x})H(φ_{2,x})dx (8)
As a default value one may set α=10. If the segmented shapes still overlap one may increase the value of α.

Following recent works in, for instance the references T. Chan and L. Vese. Active contours without edges, IEEE Transactions on Image Processing, 10(2):266-277, February 2001 and N. Paragios and R. Deriche. Geodesic active regions: a new paradigm to deal with frame partition problems in computer vision. Journal of Visual Communication and Image Representation, Special Issue on Partial Differential Equations in Image Processing, Computer Vision and Computer Graphics, 13(1/2):249-268, March/June 2002, the image term in the energy expression will be defined by using region-based intensity models. Given the overlapping constraint, the level set functions φ₁ and φ₂ define three sub-regions of the image domain: Ω₁={x,φ₁(x)>0 and φ₂(x)<0} and Ω₂={x,φ₂(x)>0 and φ₁(x)<0}, the parts inside each structure and Ω_{b}={x,φ₁(x)>0 and φ₂(x)>0}, the remaining part of the image. Assuming intensity values to be independent, the data term is defined from the prior intensity distributions {p₁,p₂,p_{b}} for each region {Ω₁,Ω₂,φ_{b}}:

$$p ( I \vert {ϕ}_{1} , {ϕ}_{2} ) = {\prod }_{x ∈ {Ω}_{1}}^{} {p}_{1} ( I ( x ) ) {\prod }_{x ∈ {Ω}_{2}}^{} {p}_{2} ( I ( x ) ) {\prod }_{x ∈ {Ω}_{b}}^{} {p}_{b} ( I ( x ) ) \qquad ( 9 )$$

If a training set is available, these probability density functions can be learned with a Parzen density estimate on the histogram of the corresponding regions. In a following section an alternative approach will be used, which will consider user inputs. The corresponding data term, which depends only on the level set functions can be written as:

$$\begin{matrix}{E}_{data} ( {ϕ}_{1} , {ϕ}_{2} ) = - {\int }_{Ω}^{} H ( {ϕ}_{1 , x} ) ( 1 - H ( {ϕ}_{2 , x} ) ) log {p}_{1} ( I ( x ) ) ⅆ x \\ - {\int }_{Ω}^{} H ( {ϕ}_{2 , x} ) ( 1 - H ( {ϕ}_{1 , x} ) ) log {p}_{2} ( I ( x ) ) ⅆ x \\ - {\int }_{Ω}^{} ( 1 - H ( {ϕ}_{2 , x} ) ( 1 - H ( {ϕ}_{1 , x} ) ) log {p}_{b} ( I ( x ) ) ⅆ x\end{matrix} \qquad ( 10 )$$

The calculus of the variations of the global energy of equation (3) with respect to φ₁ and φ₂ drives a coupled evolution of the level sets:

$$\{ \begin{matrix}\frac{\partial {ϕ}_{1}}{\partial t} = δ ( {ϕ}_{1} ) ( ( 1 - H ( {ϕ}_{2} ) ) log \frac{{p}_{b} ( I ( x ) )}{{p}_{1} ( I ( x ) )} - α H ( {ϕ}_{2} ) ) \\ \frac{\partial {ϕ}_{2}}{\partial t} = δ ( {ϕ}_{2} ) ( ( 1 - H ( {ϕ}_{1} ) ) log \frac{{p}_{b} ( I ( x ) )}{{p}_{2} ( I ( x ) )} - α H ( {ϕ}_{1} ) )\end{matrix} \qquad ( 11 )$$

One can see that the data speed becomes null as soon as the surfaces overlap each other and therefore, the non-overlapping constraint will be the only one that acts.

In a second embodiment H_{ε} is a regularized version of the Heaviside function defined as:

$${H}_{ɛ} ( ϕ ) = \{ \begin{matrix}1 , & ϕ > ɛ \\ 0 , & ϕ < - ɛ \\ \frac{1}{2} ( 1 + \frac{ϕ}{ɛ} + \frac{1}{π} sin ( \frac{πϕ}{ɛ} ) ) , & \vert ϕ \vert < ɛ .\end{matrix}$$

As in the first embodiment the non-overlapping constraint can then be introduced by adding a penalty, when the voxels are inside both structures, i.e. when H_{ε}(φ₁) and H_{ε}(φ₂) are equal to one:
p(φ_{1,x},φ_{2,x})∝exp(−αH_{ε}(φ_{1,x})H_{ε}(φ_{2,x})) (7a)
where α is a weight controlling the importance of this term. It will be shown in a next section that α can be set once for all. The corresponding term in the energy is:
E_{coupling}(φ₁,φ₂)=α∫_{Ω}H₆₈ (φ_{1,x})H_{ε}(φ_{2,x})dx (8a)
As in the earlier embodiment one may set a default value α=10. If the segmented shapes still overlap one may increase the value of 60 .

Again following earlier references, in the second embodiment, the image term in the energy expression will be defined by using region-based intensity models. Given the overlapping constraint, the level set functions φ₁ and φ₂ define three sub-regions of the image domain: Ω₁={x,φ₁(x)>0 and φ₂(x)<0} and Ω₂={x,φ₂(x)>0 and φ₁(x)<1}, the parts inside each structure and Ω_{b}={x,φ₁(x)>0 and φ₂(x)>0}, the remaining part of the image. Assuming intensity values to be independent, the data term is defined from the prior intensity distributions {p₁, p₂, p_{b}} for each region {Ω₁,Ω₂,Ω_{b}} will again lead to the earlier stated equation (9):

$$p ( I \vert {ϕ}_{1} , {ϕ}_{2} ) = {\prod }_{x ∈ {Ω}_{1}}^{} {p}_{1} ( I ( x ) ) {\prod }_{x ∈ {Ω}_{2}}^{} {p}_{2} ( I ( x ) ) {\prod }_{x ∈ {Ω}_{b}}^{} {p}_{b} ( I ( x ) ) \qquad ( 9 )$$

If a training set is available, these probability density functions can be learned with a Parzen density estimate on the histogram of the corresponding regions. In a following section an alternative approach will be used, which will consider user inputs. The corresponding data term, which depends only on the level set functions can be written as:

$$\begin{matrix}{E}_{data} ( {ϕ}_{1} , {ϕ}_{2} ) = - {\int }_{Ω}^{} {H}_{ɛ} ( {ϕ}_{1 , x} ) ( 1 - {H}_{ɛ} ( {ϕ}_{2 , x} ) ) log {p}_{1} ( I ( x ) ) ⅆ x \\ - {\int }_{Ω}^{} {H}_{ɛ} ( {ϕ}_{2 , x} ) ( 1 - {H}_{ɛ} ( {ϕ}_{1 , x} ) ) log {p}_{2} ( I ( x ) ) ⅆ x \\ - {\int }_{Ω}^{} ( 1 - {H}_{ɛ} ( {ϕ}_{2 , x} ) ( 1 - {H}_{ɛ} ( {ϕ}_{1 , x} ) ) log {p}_{b} ( I ( x ) ) ⅆ x\end{matrix} \qquad ( 10 a )$$

The calculus of the variations of the global energy of equation (3) with respect to φ₁ and φ₂ drives a coupled evolution of the level sets and can be expressed as:

$$\{ \begin{matrix}\frac{\partial {ϕ}_{1}}{\partial t} = δ ( {ϕ}_{1} ) ( ( 1 - {H}_{ɛ} ( {ϕ}_{2} ) ) log \frac{{p}_{b} ( I ( x ) )}{{p}_{1} ( I ( x ) )} - α {H}_{ɛ} ( {ϕ}_{2} ) ) \\ \frac{\partial {ϕ}_{2}}{\partial t} = δ ( {ϕ}_{2} ) ( ( 1 - {H}_{ɛ} ( {ϕ}_{1} ) ) log \frac{{p}_{b} ( I ( x ) )}{{p}_{2} ( I ( x ) )} - α {H}_{ɛ} ( {ϕ}_{1} ) )\end{matrix} \qquad ( 11 a )$$

One can see (as in equation (11a)) that the data speed becomes null as soon as the surfaces overlap each other and therefore, the non-overlapping constraint will be the only one that acts.

As mentioned earlier, the image data may not be sufficient to extract the structure of interest; therefore prior knowledge has to be introduced. When the shapes of the structures remain similar from one image to another, a shape model can be built from a set of training structures. Several types of shape models have been proposed in the literature such as in the following articles: T. Cootes, C. Taylor, D. Cooper, and J. Graham. Active shape models-their training and application. Computer Vision and Image Understanding, 61(1):38-59, 1995; D. Cremers, S. J. Osher, and S. Soatto. Kernel density estimation and intrinsic alignment for knowledge-driven segmentation: Teaching level sets to walk. Pattern Recognition, 3175:36-44, 2004; E. B. Dam, P. T. Fletcher, S. Pizer, G. Tracton, and J. Rosenman. Prostate shape modeling based on principal geodesic analysis bootstrapping. In MICCAI, volume 2217 of LNCS, pages 1008-1016, September 2004; D. Freedman, R. J. Radke, T. Zhang, Y. Jeong, D. M. Lovelock, and G. T. Chen. Model-based segmentation of medical imagery by matching distributions. IEEE Trans Med Imaging, 24(3):281-292, March 2005; M. Leventon, E. Grimson, and O. Faugeras. Statistical-Shape Influence in Geodesic Active Contours. In Proceedings of the International Conference on Computer Vision and Pattern Recognition, pages 316-323, Hilton Head Island, S.C., June 2000; M. Rousson, N. Paragios, and R. Deriche. Implicit active shape models for 3d segmentation in mr imaging. In MICCAI. Springer-Verlag, September 2004; A. Tsai, W. Wells, C. Tempany, E. Grimson, and A. Willsky. Mutual information in coupled multi-shape model for medical image segmentation. Medical Image Analysis, 8(4):429-445, December 2004.

Such models can be used to constrain the extraction of similar structures in other images. For this purpose, a straightforward approach is to estimate the instance from the modeled family that corresponds the best to the observed image. Such an approach is described in the articles: D. Cremers and M. Rousson, Efficient kernel density estimation of shape and intensity priors for level set segmentation. In MICCAI, October 2005; E. B. Dam, P. T. Fletcher, S. Pizer, G. Tracton, and J. Rosenman, Prostate shape modeling based on principal geodesic analysis bootstrapping, In MICCAI, volume 2217 of LNCS, pages 1008-1016, September 2004; and in A. Tsai, W. Wells, C. Tempany, E. Grimson, and A. Willsky, Mutual information in coupled multi-shape model for medical image segmentation. Medical Image Analysis, 8(4):429-445, December 2004. Efficient kernel density estimation of shape and intensity priors for level set segmentation. In MICCAI, October 2005. This assumes the shape model to be able to describe accurately the new structure. To add more flexibility to the extraction process, one can impose the segmentation not to belong to the shape model but to be close to it with respect to a given distance such as described in the cited references M. Rousson, N. Paragios, and R. Deriche. Implicit active shape models for 3d segmentation in mr imaging. In MICCAI. Springer-Verlag, September 2004 and D. Cremers, S. J. Osher, and S. Soatto. Kernel density estimation and intrinsic alignment for knowledge-driven segmentation: Teaching level sets to walk. Pattern Recognition, 3175:36-44, 2004. Next, a general Bayesian formulation of this shape constrained segmentation will be presented.

For the sake of simplicity, the segmentation of a single object represented by φ will be considered. Assuming a set of training shapes {φ¹, . . . , φ^{N}} available, the optimal segmentation is obtained by maximizing:

$$\begin{matrix}p ( ϕ \vert I , \{ {ϕ}^{1} , … , {ϕ}^{N} \} ) ∝ p ( I , \{ {ϕ}^{1} , … , {ϕ}^{N} \} \vert ϕ ) p ( ϕ ) \\ ∝ p ( I \vert ϕ ) p ( \{ {ϕ}^{1} , … , {ϕ}^{N} \} \vert ϕ ) p ( ϕ ) \\ ∝ p ( I \vert ϕ ) p ( ϕ \vert \{ {ϕ}^{1} , … , {ϕ}^{N} \} ) p ( \{ {ϕ}^{1} , … , {ϕ}^{N} \} ) \\ ∝ p ( I \vert ϕ ) p ( ϕ \vert \{ {ϕ}^{1} , … , {ϕ}^{N} \} )\end{matrix} \qquad ( 12 )$$

The independence between I and {φ¹, . . . , φ^{N}} is used to obtain the second line, and p({φ¹, . . . , φ^{N}})=1 provides the last line of the expressions in equations (12). The corresponding maximum a posteriori can be obtained by minimizing the following energy function:

$$E ( ϕ ) = \underbrace{- log p ( I \vert ϕ )}_{{E}_{data}} \underbrace{- log p ( ϕ \vert \{ {ϕ}^{1} , … , {ϕ}^{N} \} )}_{{E}_{shape}} \qquad ( 13 )$$

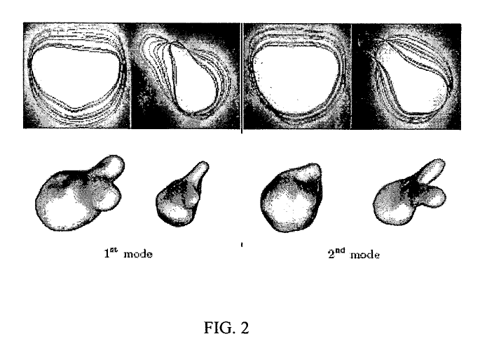

The first term integrates image data and can be defined according to the description of the image term. The second term introduces the shape constraint learned from the training samples. Following the approach as provided in the articles: M. Leventon, E. Grimson, and O. Faugeras, Statistical Shape Influence in Geodesic Active Contours. In Proceedings of the International Conference on Computer Vision and Pattern Recognition, pages 316-323, Hilton Head Island, S.C., June 2000; M. Rousson, N. Paragios, and R. Deriche. Implicit active shape models for 3d segmentation in mr imaging. In MICCAI. Springer-Verlag, September 2004; and A. Tsai, W. Wells, C. Tempany, E. Grimson, and. A. Willsky, Mutual information in coupled multi-shape model for medical image segmentation. Medical Image Analysis, 8(4):429-445, December 2004, the shape model is built from a principal component analysis of the aligned training level sets. An example of such modeling on the prostate is shown in FIG. 2. The most important modes of variation are selected to form a subspace of all possible shapes. The evolving level set can then be constrained inside this subspace as for example described in the articles A. Tsai, W. Wells, C. Tempany, E. Grimson, and A. Willsky, Mutual information in coupled multi-shape model for medical image segmentation. Medical Image Analysis, 8(4):429-445, December 2004 and D. Cremers and M. Rousson. Efficient kernel density estimation of shape and intensity priors for level set segmentation. In MICCAI, October 2005, or it can be attracted to it as described in previous cited articles M. Leventon, E. Grimson, and O. Faugeras. Statistical Shape Influence in Geodesic Active Contours. In Proceedings of the International Conference on Computer Vision and Pattern Recognition, pages 316-323, Hilton Head Island, S.C., June 2000 and M. Rousson, N. Paragios, and R. Deriche. Implicit active shape models for 3d segmentation in mr imaging. In MICCAI. Springer-Verlag, September 2004 by defining the probability of a new instance as:
p(φ|{φ¹, . . . , φ^{N}}∝exp(−d²(φ₁, Pr oj_{M}(φ))) (14)
where d²(,) is the squared distance between two level set functions and Pr oj_{M}(φ) is the projection of φ into the modeled shape subspace M. More details can be found in the following articles: M. Leventon, E. Grimson, and O. Faugeras. Statistical Shape Influence in Geodesic Active Contours. In Proceedings of the International Conference on Computer Vision and Pattern Recognition, pages 316-323, Hilton Head Island, S.C., June 2000; M. Rousson, N. Paragios, and R. Deriche. Implicit active shape models for 3d segmentation in mr imaging, In MICCAI. Springer-Verlag, September 2004; and A. Tsai, W. Wells, C. Tempany, E. Grimson, and A. Willsky. Mutual information in coupled multi-shape model for medical image segmentation. Medical Image Analysis, 8(4):429-445, December 2004.

Next this shape constrained formulation will be combined with the coupled level set Bayesian inference presented earlier for the joint segmentation of the prostate and the bladder.

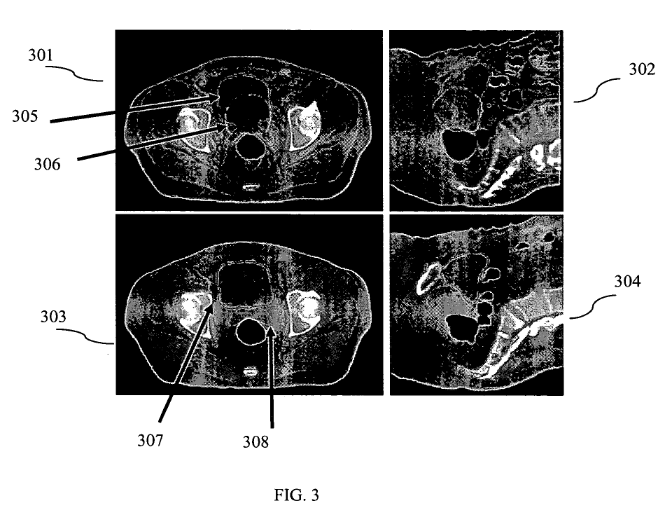

The main difficulty in segmenting the bladder is the prostate-bladder interface and the lack of reliability on the data on the lower part of the prostate as can be seen in FIG. 3. The images 301 and 302 are different views from the same patient and segmentation. Shape 305 is a joint segmentation of the bladder and the prostate without use of a coupling constraint. Shape 306 is the bladder which overlaps the prostate. The images 303 and 304 are different views from the same patient and the same segmentation but now by applying a coupling constraint in determining the segmentation. Shape 307 is the bladder and shape 308 is the prostate. No overlap has occurred in this segmentation. There seems to be a notable intensity gradient around the bladder except from the side that is neighboring the prostate. Besides, there seems to be a good statistically coherency among the shapes of the prostates from a patient population. However, the statistical coherency does not hold for the bladder shape, since the shape is dictated by the filling which can be unpredictable. Based on these arguments, a model-based approach for the extraction of the prostate only is considered. A coupled segmentation approach with a non-overlapping constraint resolves the ambiguity on the bladder-prostate interface.

To summarize, an approach is designed and here presented as an aspect of the present invention that jointly segments the prostate and the bladder by including a coupling between the organs and a shape model of the prostate. The framework provided in the present invention sections allows to express such in a probabilistic way.

Let φ₁ be the level set representing the prostate boundary and φ₂, the bladder one. Given N training shapes of the prostate {φ₁¹, . . . , φ₁^{N}}, the posterior density probability of these segmentations is:

$$p ( {ϕ}_{1} , {ϕ}_{2} \vert I , \{ {ϕ}_{1}^{1} , … , {ϕ}_{1}^{N} \} ) = \frac{p ( I , \{ {ϕ}_{1}^{1} , … , {ϕ}_{1}^{N} \} \vert {ϕ}_{1} , {ϕ}_{2} ) p ( {ϕ}_{1} , {ϕ}_{2} )}{p ( I , \{ {ϕ}_{1}^{1} , … , {ϕ}_{1}^{N} \} )} \qquad ( 15 )$$

As the image and the training contours are not correlated, this can be expressed as:
p(φ₁,φ₂|I,{φ₁¹, . . . , φ₁^{N}})∝p(I|φ₁,φ₂)p(φ₁,φ₂)p(φ₁|{φ₁¹, . . . , φ₁^{N}}) (16)

Each factor of this relation has been described previously herein. Hence, the optimal solution of the present segmentation problem should minimize the following energy:
E(φ₁,φ₂)=E_{data}(φ₁,φ₂)+E_{coupling}(φ₁,φ₂)+Eₛₕₐₚₑ(φ₁) (17)
The first two terms have been described in equation (10) and equation (8) as well as in equations (10a) and (8a). Only the shape energy needs some clarification. In the present implementation, a two step approach has been chosen. In a first step, the approach as described in the articles A. Tsai, W. Wells, C. Tempany, E. Grimson, and A. Willsky, Mutual information in coupled multi-shape model for medical image segmentation, Medical Image Analysis, 8(4):429 5, December 2004 and D. Cremers and M. Rousson. Efficient kernel density estimation of shape and intensity priors for level set segmentation. In MICCAI, October 2005, will be followed by constraining the prostate level set in the subspace obtained from the training shapes. Then, more flexibility to the surface is added by considering the constraint presented in equation (14).

For the initialization, the user is asked to click inside each organ. φ₁ and φ₂ are then initialized as small spheres centered on these two points. They also serve to define the intensity models of the organs by considering a Parzen density estimate of the histogram inside each of the two spheres while outside voxels are used for the background intensity model. The voxels inside the small spheres could be removed but given their small sizes compared to the image, this is not necessary. Because the intensity of each organ is relatively constant, its mean value can be actually guessed with a good confidence and the approach here presented does not show a big sensitivity to user inputs.

Experimental Validations

Improvements with the coupling constraint will now be demonstrated based on actual patient data. According to one aspect of the present invention a method is provided for the joint segmentation of two organs, where one incorporates a shape model and the other not. In FIG. 2, the segmentation results are shown obtained with and without coupling. In both experiments, the same shape model was considered for the prostate (with seminal vesicles). Given the absence of strong boundary between the prostate and the bladder, in the absence of coupling, the bladder leaks inside the prostate and the prostate is shifted toward the bladder. Segmenting both organs at the same time with coupling constraint solves this problem. Other methods are able to obtain correct results for the prostate without this coupling but the coupling makes it a lot more robust to the initialization and to the image quality. Moreover, imposing a shape model to the bladder is definitely not appropriate given its large variations intra- and inter-patient, and so, the coupling is essential to extract this organ in an accurate and rapid fashion.

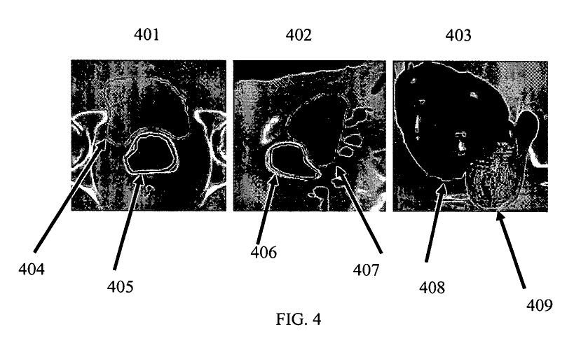

FIG. 4 shows an example of the result of applying the methods according to one aspect of the present invention. FIG. 4 has three images 401, 402 and 403 each showing the segmentation of a prostate and a bladder. Image 401 is in 2D wherein 405 is the prostate and 404 is the bladder; image 402 is in 2D wherein 406 is the prostate and 407 is the bladder; image 403 shows a depth rendering wherein 409 is the prostate and 408 is the bladder. No overlap has occurred in any of the segmentations. Note that the black outline of the prostates is based on manual segmentations of the prostate whereas the white outline represents segmentations of the prostrates in accordance with aspects of the present invention.

Validation on a Large Dataset

For evaluation purposes, several quantitative measures taken over a dataset of 16 patients for which the manual segmentation of the prostate was available were used applying the present invention. To assess the quality of the results, measures similar to the ones introduced in previously cited article D. Freedman, R. J. Radke, T. Zhang, Y. Jeong, D. M. Lovelock, and G. T. Chen. Model-based segmentation of medical imagery by matching distributions. IEEE Trans Med Imaging, 24(3):281-292, March 2005 were used. For example, the following terms can be used:
ρ_{d}, the probability of detection, calculated as the fraction of the ground truth volume that overlap with the estimated organ volume. This probability should be close to 1 for a good segmentation.
ρ_{fd}, the probability of false detection, calculated as the fraction of the estimated organ that lies outside the ground truth organ. This value should be close to 0 for a good segmentation.
C_{d}, the centroid distance, calculated as the norm of the vector connecting the centroids of the ground truth and estimated organs. The centroid of each organ is calculated using the following formula assuming the organ is made up of a collection of N triangular faces with vertices (aᵢ,bᵢ,cᵢ):

$$c = \frac{{\sum }_{i = 0}^{N - 1} {A}_{i} {R}_{i}}{{\sum }_{i = 0}^{N - 1} {A}_{i}} \qquad ( 18 )$$

where Rᵢ is the average of the vertices of the i^{th} face and Aᵢ is twice the area of the i^{th} face: Rᵢ=(aᵢ+bᵢ+cᵢ)/2 and Aᵢ=||(bᵢ−aᵢ)\textcircled{x}(cᵢ−aᵢ)||.
S_{d}, the surface distance, calculated as the median distance between the surfaces of the ground truth and estimated organs. To compute the median distance, a distance function using the ground truth volume is generated.

The resulting measures obtained on the prostate segmentation for the various dataset sets are shown in Table 1. The resolution of these images was 512×512×100 with a pixel spacing of 1 mm×1 mm×3 mm. To conduct these test, a leave- one-out strategy was used, i.e. the shape of a considered image was not used in the shape model.

The model was built from all the other images and is an inter-patient model. The average obtained accuracy is between 4 and 5 mm, i.e., between one and two voxels. The percentage of well-classified was around 82%. The average processing time on a PC with the process of 2.2 GHz is about 12 seconds.

The following table 1 shows the quantitative validation of the prostate segmentation method according to an aspect of the present invention. The columns from left to right show: patient number, probability of detection, probability of false detection, centroid distance and average surface distance.

TABLE 1

| Patient | ρ_{d} | ρ_{fd} | c_{d} (mm) | s_{d} (mm) |
|---|---|---|---|---|
| 1 | 0.93 | 0.20 | 3.5 | 4.1 |
| 2 | 0.82 | 0.12 | 5.8 | 4.2 |
| 3 | 0.88 | 0.16 | 5.2 | 4.0 |
| 4 | 0.93 | 0.19 | 4.0 | 3.9 |
| 5 | 0.84 | 0.20 | 5.5 | 4.0 |
| 6 | 0.85 | 0.22 | 5.9 | 3.7 |
| 7 | 0.89 | 0.20 | 3.4 | 2.9 |
| 8 | 0.84 | 0.28 | 3.1 | 4.5 |
| 9 | 0.80 | 0.35 | 8.7 | 4.9 |
| 10 | 0.88 | 0.27 | 8.0 | 4.3 |
| 11 | 0.67 | 0.19 | 4.8 | 3.7 |
| 12 | 0.84 | 0.35 | 8.6 | 6.7 |
| 13 | 0.73 | 0.20 | 7.7 | 5.4 |
| 14 | 0.83 | 0.09 | 2.3 | 3.1 |
| 15 | 0.84 | 0.19 | 4.0 | 4.0 |
| 16 | 0.85 | 0.15 | 3.2 | 3.7 |
| Average | 0.84 | 0.21 | 5.2 | 4.2 |

Consequently a novel Bayesian framework to segment jointly several structures has been presented as an aspect of the present invention. A probabilistic approach that integrates a coupling between the surfaces and prior shape knowledge has also been presented. Its general formulation has been adapted to the important problem of prostate segmentation for radiotherapy. By coupling the extraction of the prostate and bladder, the segmentation problem has been constrained and has been made it well-posed. Qualitative and quantitative results were presented to validate the performance of the proposed approach.

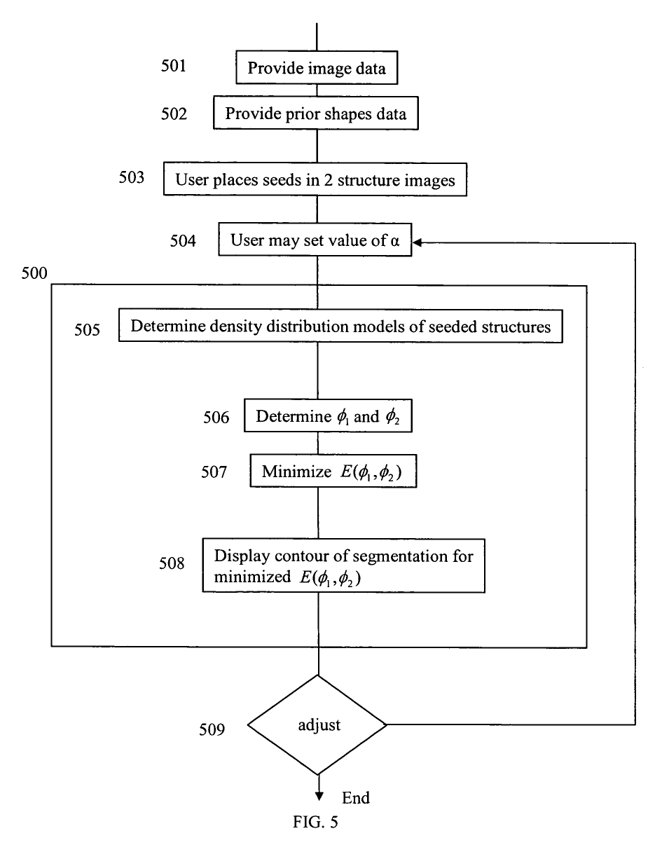

FIG. 5 provides a flow diagram illustrating the steps according to an aspect of the present invention. The flow diagram shows a sequential order to all steps. It should be clear that for some steps the order does not matter. The segmentation process is started by providing the image data (501) and when required with the prior shapes data (502). The user then places a seeding point in each of the two structures (503). The user may set manually a value for the overlap penalty α (504). However the application may also start with a default value for α. The application (500) then determines the density distribution (505) of the structures and by executes the level set functions (507). The application minimizes the energy expression (508) which includes the one or two constraints and displays the segmented contours of the structures (508). Based on analysis of a user (509) one may decide that overlap still exists and re-run the application after adjusting the penalty factor α.

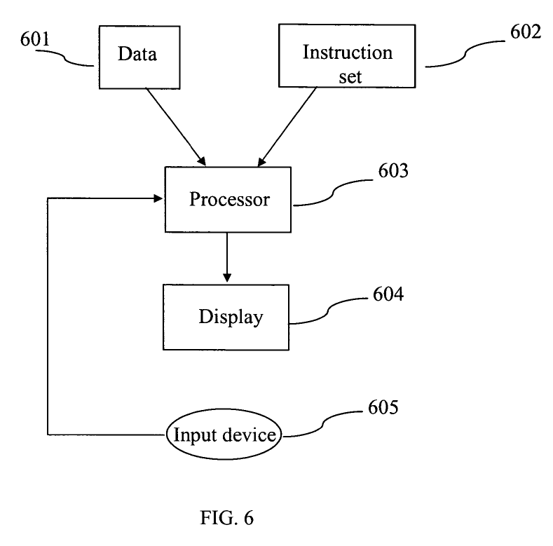

FIG. 6 illustrates a computer system that can be used in accordance with one aspect of the present invention. The system is provided with data 601 representing the to be displayed image. It may also include the prior learning data. An instruction set or application program 602 comprising the methods of the present invention is provided and combined with the data in a processor 603, which can process the instructions of 602 applied to the data 601 and show the resulting image on a display 604. The processor can be dedicated hardware, a GPU, a CPU or any other computing device that can execute the instructions of 602. An input device 605 like a mouse, or track-ball or other input device allows a user to initiate the segmentation process and to place the initial seeds in the to be segmented organs. Consequently the system as shown in FIG. 6 provides an interactive system for image segmentation.

Any reference to the term pixel herein shall also be deemed a reference to a voxel.

The following references provide background information generally related to the present invention and are hereby incorporated by reference: [1] T. Chan and L. Vese. Active contours without edges. IEEE Transactions on Image Processing, 10(2):266-277, February 2001; [2] T. Cootes, C. Taylor, D. Cooper, and J. Graham. Active shape models-their training and application. Computer Vision and Image Understanding, 61(1):38-59, 1995; [3] D. Cremers, S. J. Osher, and S. Soatto. Kernel density estimation and intrinsic alignment for knowledge-driven segmentation: Teaching level sets to walk. Pattern Recognition, 3175:36-44, 2004; [4] D. Cremers and M. Rousson. Efficient kernel density estimation of shape and intensity priors for level set segmentation. In MICCAI, October 2005; [5] E. B. Dam, P. T. Fletcher, S. Pizer, G. Tracton, and J. Rosenman. Prostate shape modeling based on principal geodesic analysis bootstrapping. In MICCAI, volume 2217 of LNCS, pages 1008-1016, September 2004; [6] D. Freedman, R. J. Radke, T. Zhang, Y. Jeong, D. M. Lovelock, and G. T. Chen. Model-based segmentation of medical imagery by matching distributions. IEEE Trans Med Imaging, 24(3):281-292, March 2005; [7] M. Leventon, E. Grimson, and O. Faugeras. Statistical Shape Influence in Geodesic Active Contours. In Proceedings of the International Conference on Computer Vision and Pattern Recognition, pages 316-323, Hilton Head Island, S.C., June 2000; [8] S. Osher and J. Sethian. Fronts propagating with curvature dependent speed: algorithms based on the Hamilton-Jacobi formulation. J. of Comp. Phys., 79:12-49, 1988; [9] N. Paragios and R. Deriche. Geodesic active regions: a new paradigm to deal with frame partition problems in computer vision. Journal of Visual Communication and Image Representation, Special Issue on Partial Differential Equations in Image Processing, Computer Vision and Computer Graphics, 13(1/2):249-268, March/June 2002; [10] M. Rousson, N. Paragios, and R. Deriche. Implicit active shape models for 3d segmentation in mr imaging. In MICCAI. Springer-Verlag, September 2004; [11] A. Tsai, W. Wells, C. Tempany, E. Grimson, and A. Willsky. Mutual information in coupled multi-shape model for medical image segmentation. Medical Image Analysis, 8(4):429-445, December 2004.

According to one aspect of the present invention the segmentation of two structures is determined by minimizing an energy function comprising structure data and one constraint and according to a further aspect comprising structure data and two constraints. In the present invention the energy term is created by the addition of individual terms. Addition of these terms may make the minimization process easier to execute. It should be clear that other ways exist to combine the constraining terms with the data term. In general one may consider E=f(E_{data}, E_{coupling}) or E=g(E_{data}, E_{coupling}, Eₛₕₐₚₑ) wherein the combined energy is a function of the individual terms. The individual terms are depending from a shape determining property, such as a level set function. The equation E=E_{data}+E_{coupling} is one example of the generalized solution. One can find the optimal segmentation by optimizing the combined energy function.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

What is claimed.

1. A method for segmenting a first structure and a second structure from image data, comprising:
forming an energy function E=f(E_{data}, E_{coupling}) wherein E_{data} represents a possible segmentation based on the first structure and the second structure and E_{coupling} represents a measure of overlap between the first structure and the second structure; and
minimizing the energy function.

2. The method as claimed in claim 1, wherein E=E_{data}+E_{coupling}.

3. The method as claimed in claim 2, wherein E_{data} and E_{coupling} are logarithmic expressions.

4. The method as claimed in claim 1, wherein the terms E_{data} and E_{coupling} depend on the probability of a level set function of the first structure and of the second structure.

5. The method as claimed in claim 4, wherein E_{coupling} depends on a penalty α.

6. The method as claimed in claim 5, wherein the term E_{data} is expressed as:
$$\begin{matrix}{E}_{data} ( {ϕ}_{1} , {ϕ}_{2} ) = - {\int }_{Ω}^{} {H}_{ɛ} ( {ϕ}_{1 , x} ) ( 1 - {H}_{ɛ} ( {ϕ}_{2 , x} ) ) log {p}_{1} ( I ( x ) ) ⅆ x \\ - {\int }_{Ω}^{} {H}_{ɛ} ( {ϕ}_{2 , x} ) ( 1 - {H}_{ɛ} ( {ϕ}_{1 , x} ) ) log {p}_{2} ( I ( x ) ) ⅆ x \\ - {\int }_{Ω}^{} ( 1 - {H}_{ɛ} ( {ϕ}_{2 , x} ) ( 1 - {H}_{ɛ} ( {ϕ}_{1 , x} ) ) log {p}_{b} ( I ( x ) ) ⅆ x\end{matrix}$$
and the term E_{coupling} is expressed as:
E_{coupling}(φ₁,φ₂)=α∫_{Ω}H_{ε}(φ_{1,x})H_{ε}(φ_{2,x})dx.

7. The method as claimed in claim 2, wherein a third term Eₛₕₐₚₑ is added which expresses a constraint of learned prior shapes.

8. The method as claimed in claim 7, wherein the term Eₛₕₐₚₑ can be expressed as Eₛₕₐₚₑ=−log p(φ|{φ¹, . . . , φ^{N}}.

9. The method as claimed in claim 5, where α is user defined.

10. The method as claimed in claim 1 wherein the first structure is a prostate and the second structure is a bladder.

11. A system that can segment a first structure and a second structure from image data, comprising:
a processor;
application software operable on the processor to:
form an energy function E=f(E_{data}, E_{coupling}) wherein E_{data} represents a possible segmentation based on the first structure and the second structure and E_{coupling} represents a measure of overlap between the first structure and the second structure; and
minimize the energy function.

12. The system as claimed in claim 11, wherein E=E_{data}+E_{coupling}.

13. The system as claimed in claim 12, wherein. E_{data} and E_{coupling} are logarithmic expressions.

14. The system as claimed in claim 11, wherein the terms E_{data} and E_{coupling} depend on the probability of a level set function of the first structure and of the second structure.

15. The system as claimed in claim 14, wherein E_{coupling} depends on a penalty α.

16. The system as claimed in claim 15, wherein the term E_{data}, is expressed as:
$$\begin{matrix}{E}_{data} ( {ϕ}_{1} , {ϕ}_{2} ) = - {\int }_{Ω}^{} {H}_{ɛ} ( {ϕ}_{1 , x} ) ( 1 - {H}_{ɛ} ( {ϕ}_{2 , x} ) ) log {p}_{1} ( I ( x ) ) ⅆ x \\ - {\int }_{Ω}^{} {H}_{ɛ} ( {ϕ}_{2 , x} ) ( 1 - {H}_{ɛ} ( {ϕ}_{1 , x} ) ) log {p}_{2} ( I ( x ) ) ⅆ x \\ - {\int }_{Ω}^{} ( 1 - {H}_{ɛ} ( {ϕ}_{2 , x} ) ( 1 - {H}_{ɛ} ( {ϕ}_{1 , x} ) ) log {p}_{b} ( I ( x ) ) ⅆ x\end{matrix}$$
and the term E_{coupling} is expressed as:
E_{coupling}(φ₁,φ₂)=α∫_{Ω}H_{ε}(φ_{1,x})H_{ε}(φ_{2,x})dx.

17. The system as claimed in claim 12, wherein a third term Eₛₕₐₚₑ is added which expresses a constraint of learned prior shapes.

18. The system as claimed in claim 17, wherein the term Eₛₕₐₚₑ can be expressed as Eₛₕₐₚₑ=−log p(φ|{φ¹, . . . , φ^{N}}.

19. The system as claimed in claim 15, where α is user defined.

20. The system as claimed in claim 11 wherein the first structure is a prostate and the second structure is a bladder.
